(19) United States
(12) Patent Application Publication
(10) Pub. No.: US 2004/0079782 A1
(43) Pub. Date: Apr. 29, 2004

(54) Electric stapler

(75) Inventor: Zhen Yu Luo, Tsing Yi (HK)

Correspondence Address: LEYDIG VOIT & MAYER, LTD, 700 THIRTEENTH ST. NW, SUITE 300, WASHINGTON, DC, 20005-3960, US

(73) Assignee: Ming Sun Enterprises (China) Limited, Tsing Yi (HK)

(21) Appl. No.: 10/281,239

(22) Filed: Oct. 28, 2002

(51) Int. Cl. B25C 5/06

(52) U.S. Cl. 227/131

(57) ABSTRACT

An electric stapler includes a frame, a motor mounted to the frame, a reduction gearbox connected to the motor, a cutter blade mounted to the frame for severing individual staples from an array of staples, an anvil against which the staples are deformed by the cutter blade, and a rotational element connected to the gearbox to be rotated thereby on demand, the rotational element including an off-centre pin co-operating with the cutter blade to effect linear movement of the cutter blade upon rotation of the disc. The gearbox typically includes a series array of interconnected modules, each housing at least one gear. A pivot secures the frame to the base such that a gap between the anvil and the cutter is adjusted according to sheet thickness as a result of sheet insertion over the anvil prior to activation of the motor.

### BACKGROUND OF THE INVENTION

The present invention relates to electric staplers. More particularly, although not exclusively, the invention relates to an electric stapler having an improved cutter blade driving mechanism, a modular gearbox and a paper thickness adjustment mechanism.

Electric staplers are known and often comprise complex mechanisms for driving the cutter blade and no means of adjusting the space between the cutter blade and the anvil to accommodate different paper thicknesses.

### OBJECTS OF THE INVENTION

It is an object of the present invention to overcome or substantially ameliorate at least one of the above disadvantages and/or more generally to provide an improved electric stapler.

### DISCLOSURE OF THE INVENTION

There is disclosed herein an electric stapler comprising:

a frame,

a motor mounted to the frame,

a reduction gearbox connected to the motor,

a cutter blade mounted to the frame for severing individual staples from an array of staples,

an anvil against which the staples are deformed by the cutter blade, and

a rotational element connected to the gearbox to be rotated thereby on demand, the rotational element co-operating with the cutter blade to effect linear movement thereof upon rotation of the rotational element.

Preferably the rotational element and the cutter blade; reside in parallel planes.

Preferably the rotational element is a disc having a pin extending therefrom and the cutter blade includes a cutter blade block having a transverse slot therein and into which the pin is received.

Preferably the pin is attached to all co-operates with a pin block slidably received within the slot.

Preferably the stapler further comprises a micro-switch against which an edge of sheets to be stapled engaged to activate the motor.

Preferably there is another micro-switch against which the cutter blade-block bears to deactivate the motor upon return of the cutter blade to a start position.

There is further disclosed herein an electric stapler comprising:

an electric motor,

a cutter blade, and

a gearbox for transmitting output torque from the electric motor to the cutter blade, the gearbox comprising a series array of interconnected modules, each housing at least one gear, wherein a gear located within one module meshes with a gear located in an adjacent module.

Preferably bolts passing through all the interconnect modules.

Preferably gears of each module are mounted upon a common shaft passing through all of the modules.

Preferably other gears of each module are mounted upon another common shaft passing through all the modules.

Preferably the modules are mounted upon a frame on which the motor is also mounted.

Preferably the modules are made of plastics material.

Preferably the gears are made of a plastics material.

There is further disclosed herein an electric stapler comprising:

a base having a staple-engaging anvil,

a frame comprising a motor and staple-delivery means driven by the motor for forcing individual staples loaded into the frame to be deformed against the anvil through a sheet, and

a pivot securing the frame to the base such that a gap between the anvil and the staple delivery means is adjusted according to sheet thickness as a result of sheet insertion over the anvil prior to activation of the motor.

Preferably the pivot includes a linkage connected pivotally at one end thereof to the base.

Preferably the linkage is connected pivotally at its other end to the base.

Preferably the linkage extends between the base and the frame at a position intermediate respective ends thereof.

### BRIEF DESCRIPTION OF THE DRAWINGS

A preferred form of the present invention will now be described by way of example with reference to the accompanying drawings, wherein:

FIG. 1 is a schematic perspective illustration of an electric stapler mechanism,

FIG. 2 is a schematic cross-sectional side elevational view of the mechanism of FIG. 1 with its cutting blade in a raised position,

FIG. 3 is a schematic cross-sectional elevational view of the stapler mechanism having its cutting blade in a partly lowered position,

FIG. 4 is a schematic cross-sectional elevational view of the stapler mechanism having its cutting blade in its lower-most position wherein a staple is deformed against an anvil,

FIGS. 5 to 13 a schematic end elevational views of parts of the state the mechanism showing various positions of the cutting blade,

FIG. 14 is a schematic side elevational view of the state the mechanism,

FIG. 15 is a schematic parts-exploded perspective illustration of gearbox parts of the stapler,

FIG. 16 is a schematic perspective illustration of other parts of the stapler including its motor,

FIG. 17 is a schematic side elevational view of the stapler mechanism illustrating pivot movement of its frame,

FIG. 18 is a schematic perspective illustration of the stapler mechanism, and

FIG. 19 is a schematic parts-exploded perspective illustration of the stapler mechanism.

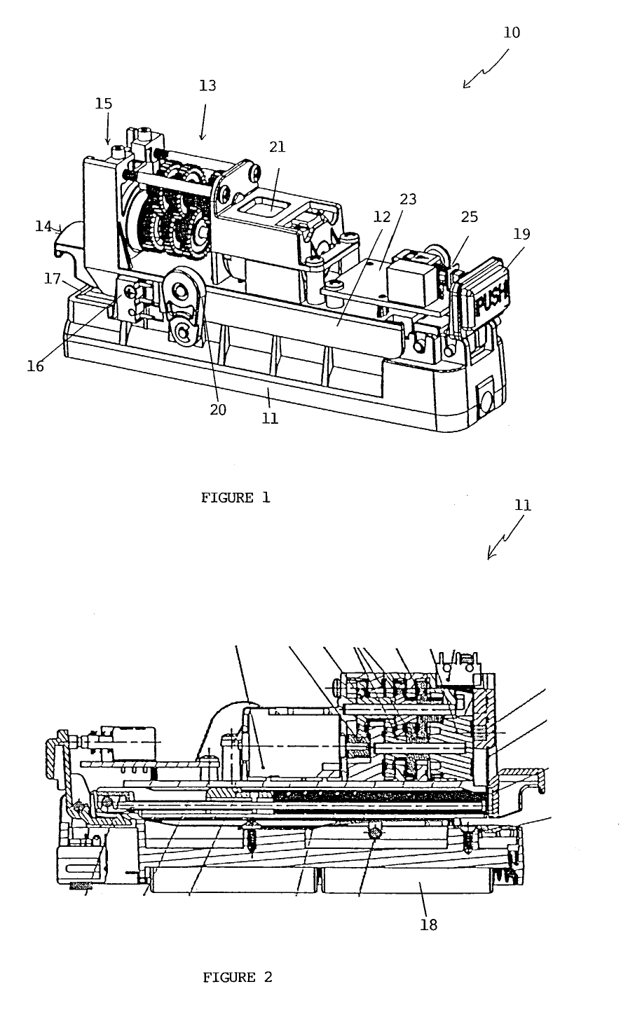

### DESCRIPTION OF THE PREFERRED EMBODIMENT

In the accompanying drawings there is schematically depicted a stapler mechanism 10. Mechanism 10 includes a base 11 supporting a framed 12. These components are typically fabricated from plastics material. A pivot linkage 20 connects the framed 12 to the base 11.

There is an electric motor 21 mounted within the frame 12 and a gearbox 13 transmitting torque from the motor to a cutting blade that rides vertically within a track 15.

The base 11 includes an anvil 17. There is a staple cassette handle 14 projecting from the front of the staple mechanism and it is affixed to a staple cassette 24 into which a standard row of interconnected staples can be received.

There is a trigger switch 16 adjacent to the anvil 17 against which edges of sheets of material such as paper to be stapled together can press to trigger a stapling operation.

There is a printed circuit board 23 mounted to the frame 12 upon which there is another switch 25 activated by a pushbutton 19 to release the staple cassette. There are other components mounted on the printed circuit board for providing logic control to the motor 21 upon receiving trigger signals from the various switches.

Within the cutting blade track 15 there is slidably received a cutting blade 27 affixed to a cutting blade block 26. The block 26 rides along the track 15 so that the blade 27 projecting downwardly therefrom moves in a vertical plane,,being the plane normal to the sheets of material and in which stapling takes place. There is another switch 25 mounted to the frame and against which the cutting blade block 26 can bear to signal when the cutting blade returns to its start position as shown in FIG. 2.

A number of batteries 18 are located within a battery compartment in the base 11. The batteries provide power to the electric motor via the switches as described.

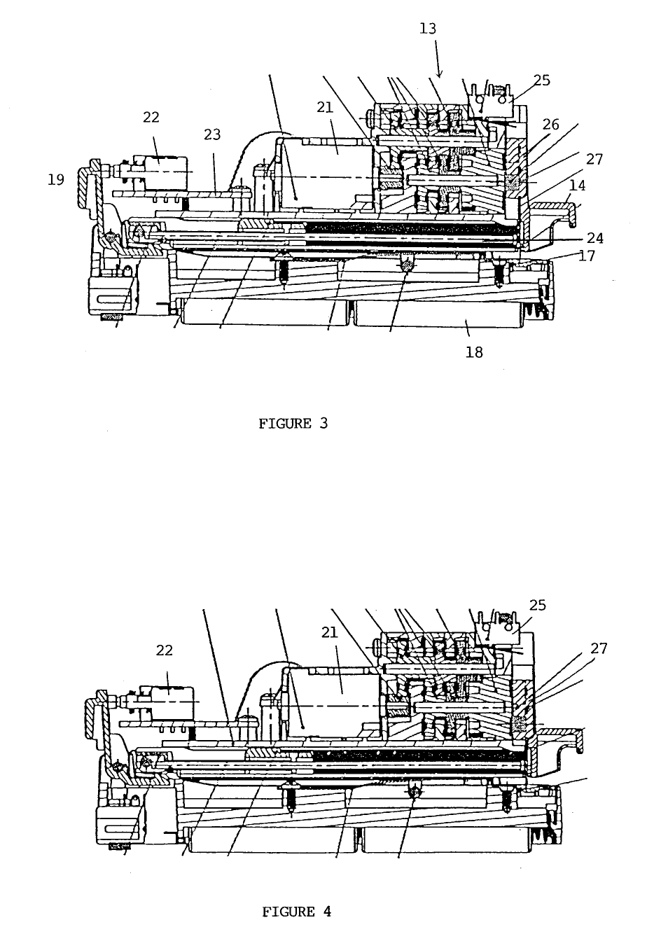

The output gear of the electric motor 21 enters the gearbox 13 as shown in FIG. 3.

With reference to FIGS. 5 to 13, the cutting blade block 26 is seen to have a horizontal slot 28 formed therein. Within this slot slides a pin block 36 formed integrally with a pin 29 (alternatively, the pin might rotate within the pin block 36). The pin 29 co-operates with a rotational element such as a disc 30. Moreover the pin 29 is received within an eccentric hole within the disc 30 (alternatively, that in mind deformed integrally with the disc). Disc 30 has attached to its back one of the gears 33 to be described later. Needless to say, upon activation of motor 21, the gearbox 13 transmits torque to the disc 30 to effect arcuate movement of the pin and pin block 36. As the pin block 36 is received within the horizontal slot 28 of the cutting blade block 26, vertical movement of the cutting blade block 26 results from rotation of the disc.

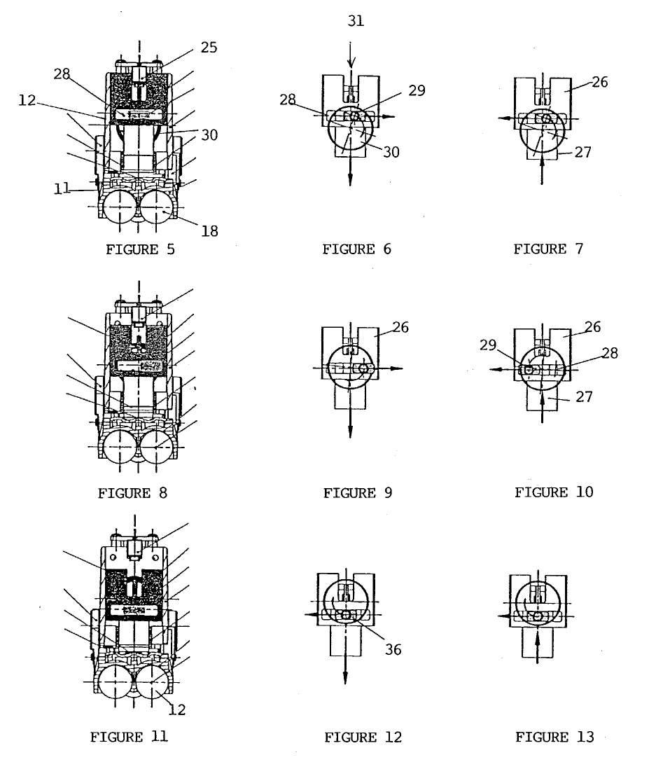

Starting from FIG. 6, and progressing through FIGS. 9, 12, 13, 10 and 7, it can be seen that from the start position in FIG. 6, clockwise rotation of the disc 30 causes the commencement of downward movement of the cutting blade 27. At the bottom position shown in FIG. 12, (when a staple severed from its array within the cassette has connected the sheets of paper together), upward return of the cutting blade 27 commences until the position shown in FIG. 7 is reached. At this point the cutting blade block 26 engages the micro-switch 25 to signal logic circuitry on the printed circuit board to cease the supply of current from the batteries 18 to the motor 21. Commencement of this operation occurs when the edge of the paper touches the first micro-switch 16.

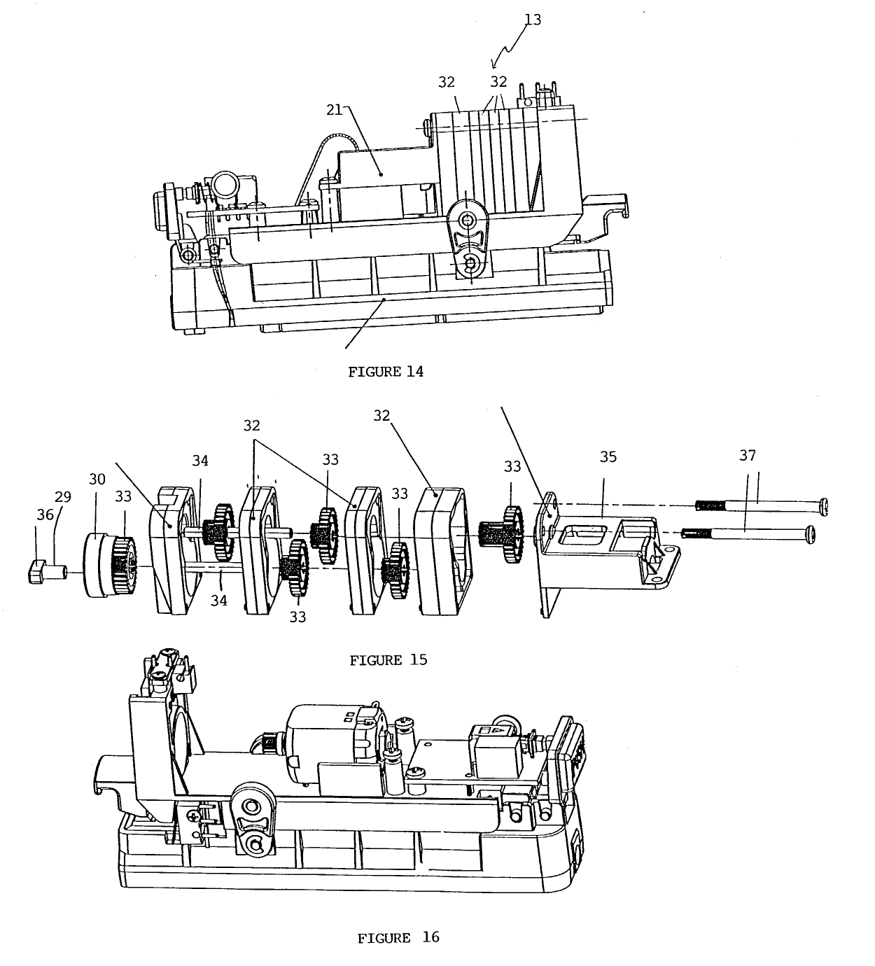

With reference to FIGS. 14 to 16, the gearbox 13 is seen to comprise a number of the gearbox casing modules 32. These are typically fabricated from plastics material. Typically, each module is moulded. Alternatively and/or additionally, each module is machined from a block of plastics material. Bolts 37 passing longitudinally through all of the modules connect them together to form a gearbox casing. Bolts 37 can receive nuts upon their thread ends, or might be threaded directly into the plastics material from which the last casing modules 32 is made. A number of discs 33 are supported rotatably upon respective common shafts 34 that also extend throughout the whole length of the modular gearbox. Each gear cluster comprises a large diameter gear and a small diameter gear. These gears intermesh in a stepwise manner so as to provide a significant reduction in speed and increase in torque. That is, whereas the motor is high-speed, low-torque, rotation of the disc 30 is low-speed, high-torque. This modular arrangement means that by inserting extra modules and gears, and increased gear ratio is provided.

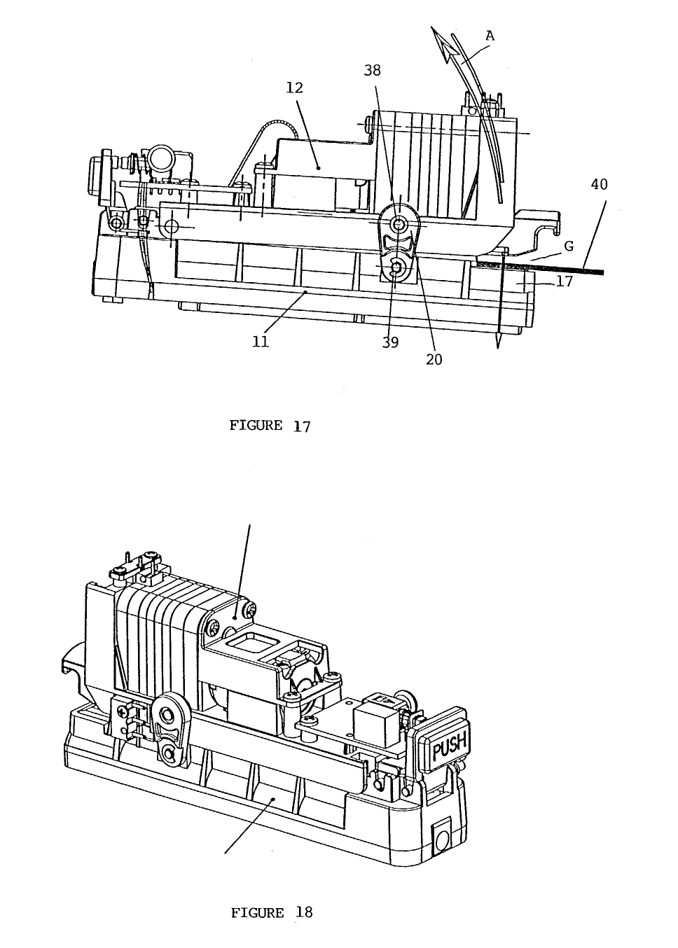

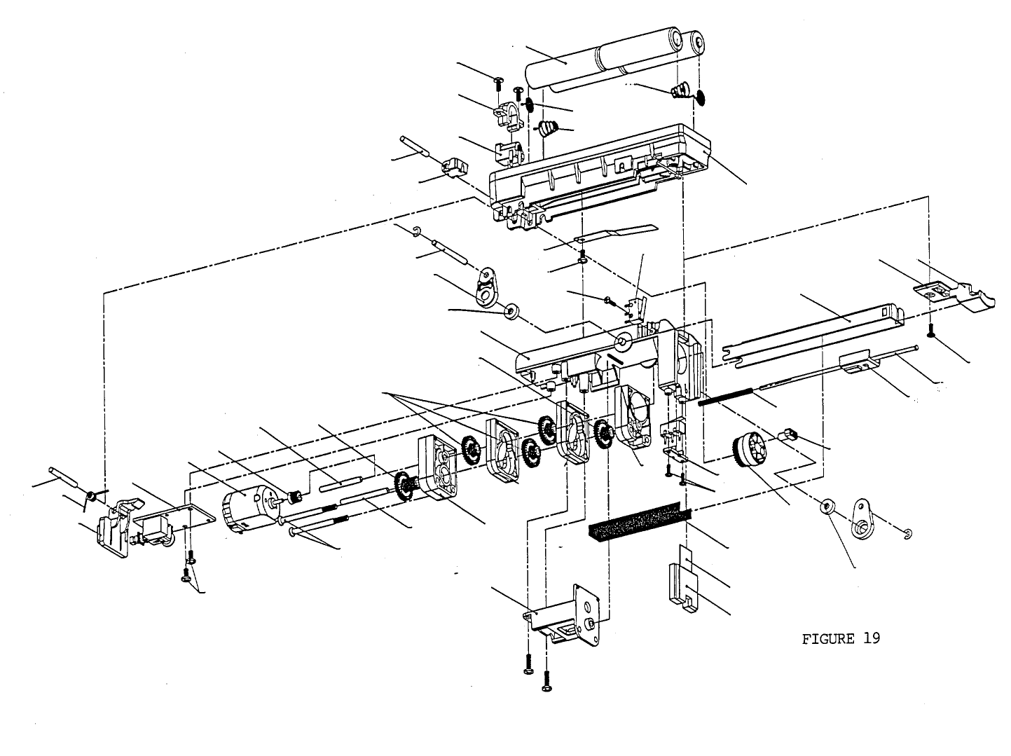

As shown in FIGS. 17 and 18, the frame 12 is mounted to the base 11 by the pivot linkage 20. Linkage 20 is pivotally connectedcrore for a the at 38 to the frame 12 and also pivotally connected at 39 to the base 11. That is, the frame and base are connected pivotally at an intermediate position between the front and back ends thereof. Sheets of paper or other material 40 are placed upon the handle 17 and if they are too thick for the resting gap G (FIG. 17), the frame 12 will pivot upwardly as indicated by arrow A.

It should be appreciated that modifications and alterations obvious to those skilled in the art are not to be considered as beyond the scope of the present invention. For example instead of being battery-powered, the stapler might be powered by an external plug pack. Also, the position of linkage 20 can be changed to be further back toward the pushbutton 19.

1. An electric stapler comprising:
a frame,
a motor mounted to the frame,
a reduction gearbox connected to the motor,
a cutter blade mounted to the frame for severing individual staples from an array of staples,
an anvil against which the staples are deformed by the cutter blade, and
a rotational element connected to the gearbox to be rotated thereby on demand, the rotational element co-operating with the cutter blade to effect linear movement thereof upon rotation of the rotational element.

2. The stapler of claim 1 wherein the rotational element and the cutter blade reside in parallel planes.

3. The stapler of claim 1 wherein the rotational element is a disc having a pin extending therefrom and the cutter blade includes a cutter blade block having a transverse slot therein and into which the pin is received.

4. The stapler of claim 3 wherein the pin is attached to all co-operates with a pin block slidably received within the slot.

5. The stapler of claim 1 further comprising a micro-switch against which an edge of sheets to be stapled engaged to activate the motor.

6. The stapler of claim 3 comprising a micro-switch against which the cutter blade block bears to deactivate the motor upon return of the cutter blade to a start position.

7. An electric stapler comprising:
an electric motor,
a cutter blade, and
a gearbox for transmitting output torque from the electric motor to the cutter blade, the gearbox comprising a series array of interconnected modules, each housing at least one gear, wherein a gear located within one module meshes with a gear located in an adjacent module.

8. The stapler of claim 7 further comprising bolts passing through all the interconnect modules.

9. The stapler of claim 7 wary and gears of each module are mounted upon a common shaft passing through all of the modules.

10. The stapler of claim 9 wherein other gears of each module are mounted upon another common shaft passing through all the modules.

11. The stapler of claim 7 wherein the modules are mounted upon a frame on which the motor is also mounted.

12. The stapler of claim 7 wherein the modules are made of plastics material.

13. The stapler of claim 7 wherein the gears are made of a plastics material.

14. An electric stapler comprising:
a base having a staple-engaging anvil,
a frame comprising a motor and staple-delivery means driven by the motor for forcing individual staples loaded into the frame to be deformed against the anvil through a sheet, and
a pivot securing the frame to the base such that a gap between the anvil and the staple delivery means is adjusted according to sheet thickness as a result of sheet insertion over the anvil prior to activation of the motor.

15. The stapler of claim 14 wherein the pivot includes a linkage connected pivotally at one end thereof to the base.

16. The stapler of claim 15 wherein the linkage is connected pivotally at its other end to the base.

17. The stapler of claim 16 wherein the linkage extends between the base and the frame at a position intermediate respective ends thereof.
